(19) United States
(12) Patent Application Publication
(10) Pub. No.: US 2006/0197881 A1
(43) Pub. Date: Sep. 7, 2006

(54) Organic thin film transistor array panel and manufacturing method thereof

(76) Inventors: Beo-Deul Kang, Seoul (KR); Keun-Kyu Song, Yongin-si (KR)

Correspondence Address: CANTOR COLBURN, LLP, 55 GRIFFIN ROAD SOUTH, BLOOMFIELD, CT, 06002, US

(21) Appl. No.: 11/368,013

(22) Filed: Mar. 3, 2006

(30) Foreign Application Priority Data
Mar. 3, 2005 (KR) 10-2005-0017670

(51) Int. Cl. G02F 1/1343

(52) U.S. Cl. 349/38

(57) ABSTRACT

An organic thin film transistor array panel according to an exemplary embodiment of the present invention includes: a substrate; data lines disposed on the substrate; a storage connection disposed on the substrate; gate lines intersecting the data lines and including gate electrodes; storage electrode lines separated from the gate lines and connected to the storage connection; a gate insulating layer disposed on the gate lines and the storage electrode lines and having contact holes exposing the data lines; first electrodes disposed on the gate insulating layer and connected to the data lines through the contact holes; second electrodes disposed opposite the first electrodes with respect to the gate electrodes; storage covers disposed on the gate insulating layer opposite the storage connection; and organic semiconductors disposed on the first and the second electrodes and contacting the first and the second electrodes.

This application claims priority to Korean Patent Application No. 10-2005-0017670, filed on Mar. 3, 2005 and all the benefits accruing therefrom under 35 U.S.C. §119, and the contents of which in its entirety are herein incorporated by reference.

### BACKGROUND OF THE INVENTION

(a) Field of the Invention

The present invention relates to an organic thin film transistor array panel and a manufacturing method thereof.

(b) Description of Related Art

Organic thin film transistors (“OTFT”) are vigorously developed as driving elements for next-generation display devices.

An OTFT includes an organic active layer instead of an inorganic semiconductor layer such as silicon (Si). In particular, since organic insulating material can be easily deposited in the form of a fiber or a film at a low temperature by spin coating or vacuum evaporation, the OTFT is spotlighted as significant elements in flexible display devices.

Since a display panel having OTFTs may have a structure different from a conventional display panel, an OTFT array panel may be manufactured using a method different from a method of manufacturing a conventional thin film transistor (“TFT”) array panel. In particular, a new structure is required in order to provide stable voltages, such as a common voltage, to signal lines on the OTFT array panel.

### BRIEF SUMMARY OF THE INVENTION

An organic thin film transistor array panel according to an exemplary embodiment of the present invention includes: a substrate; a plurality of data lines disposed on the substrate; a storage connection disposed on the substrate; a plurality of gate lines intersecting the data lines and including gate electrodes; a plurality of storage electrode lines separated from the gate lines and connected to the storage connection; a gate insulating layer disposed on the gate lines and the storage electrode lines and having contact holes exposing the data lines; a plurality of first electrodes disposed on the gate insulating layer and connected to the data lines through the contact holes; a plurality of second electrodes disposed opposite the first electrodes relative to respective corresponding gate electrodes; a plurality of storage covers disposed on the gate insulating layer opposite the storage connection; and a plurality of organic semiconductors disposed on the first and the second electrodes and contacting the first and the second electrodes.

The storage covers may be disposed on the same layer as the second electrodes. The storage covers and the second electrodes may include amorphous or crystalline ITO. The storage covers may fully cover an entire width of the storage connection.

The organic semiconductors may include at least one selected from pentacene, phthalocyanine, and thiophene.

The organic thin film transistor array panel may further include a plurality of insulators disposed on the organic semiconductors. The insulators may include a hydrocarbon based polymer including fluorine or polyvinyl alcohol.

The organic thin film transistor array panel may further include an interlayer insulating layer disposed between the data lines and the gate lines. The interlayer insulating layer may include a silicon nitride film and an organic film.

The gate insulating layer may include silicon oxide treated with octadecyl trichloro silane (OTS), maleimide-styrene, and parylene.

The organic thin film transistor array panel may further include a plurality of conductive light blocking members.

The organic thin film transistor array panel may further include a plurality of passivation members disposed on the organic semiconductors.

A method of manufacturing an organic thin film transistor array panel according to another exemplary embodiment of the present invention includes: forming data lines and a storage connection; depositing an interlayer insulating layer on the data lines and the storage connection; forming first contact holes exposing portions of the data lines and second contact holes exposing the storage connection at the interlayer insulating layer; forming gate lines including gate electrodes and storage electrode lines on the interlayer insulating layer, the storage electrode lines connected to the storage connection through the second contact holes; depositing a gate insulating layer on the gate lines and the storage electrode lines; forming third contact holes exposing the first contact holes; forming source electrodes, pixel electrodes and storage covers, the source electrodes connected to the data lines through the first and the third contact holes, the pixel electrodes including drain electrodes disposed opposite the source electrodes; and forming organic semiconductors on the source electrodes and the drain electrodes.

The formation of source electrodes, pixel electrodes and the storage covers may include: depositing an ITO layer; and patterning the ITO layer by lithography and etching. The deposition of the ITO layer may be performed at room temperature and the patterning of the ITO layer may use an etchant containing an alkaline ingredient.

The storage covers may fully cover an entire width of the storage connection.

The formation of the organic semiconductors may include one of spin coating, vacuum evaporation and printing.

The method may further include: forming stoppers on the organic semiconductors. The stoppers may include a hydrocarbon based polymer including fluorine or polyvinyl alcohol.

The method may include: forming a passivation members on the organic semiconductors.

The formation of the interlayer insulating layer may include: forming a first insulating layer including silicon nitride; and forming a second insulating layer including an organic material.

The formation of the data lines and the storage connection may form light blocking members under the corresponding gate electrodes.

### BRIEF DESCRIPTION OF THE DRAWINGS

The present invention will become more apparent by describing embodiments thereof in detail with reference to the accompanying drawing in which:

FIG. 1 is a plan view layout of an exemplary embodiment of an organic TFT array panel according to the present invention;

FIG. 2 is a sectional view of the organic TFT array panel shown in FIG. 1 taken along line II-II′;

FIG. 3 is a sectional view of the organic TFT array panel shown in FIG. 1 taken along line III-III′;

FIGS. 4, 6, 8, 10, 12 and 14 are plan view layouts of the organic TFT array panel shown in FIGS. 1-3 illustrating intermediate steps of an exemplary embodiment of a manufacturing method thereof according to the present invention;

FIGS. 5A and 5B are cross-sectional views of the TFT array panel shown in FIG. 4 taken along lines VA-VA′ and VB-VB′;

FIGS. 7A and 7B are sectional views of the TFT array panel shown in FIG. 6 taken along lines VIIA-VIIA′ and VIIB-VIIB′;

FIGS. 9A and 9B are cross-sectional views of the TFT array panel shown in FIG. 8 taken along lines IXA-IXA′ and IXB-IXB′;

FIGS. 11A and 11B are cross-sectional views of the TFT array panel shown in FIG. 10 taken along lines XIA-XIA′ and XIB-XIB′;

FIGS. 13A and 13B are cross-sectional views of the TFT array panel shown in FIG. 12 taken along lines XIIIA-XIIIA′ and XIIIB-XIIIB′; and

FIG. 15 is a cross-sectional view of the TFT array panel shown in FIG. 14 taken along line XV-XV′.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the exemplary embodiments set forth herein, where like reference numerals refer to like elements throughout.

In the drawings, the thickness of layers and regions are exaggerated for clarity. It will be understood that when an element such as a layer, region or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

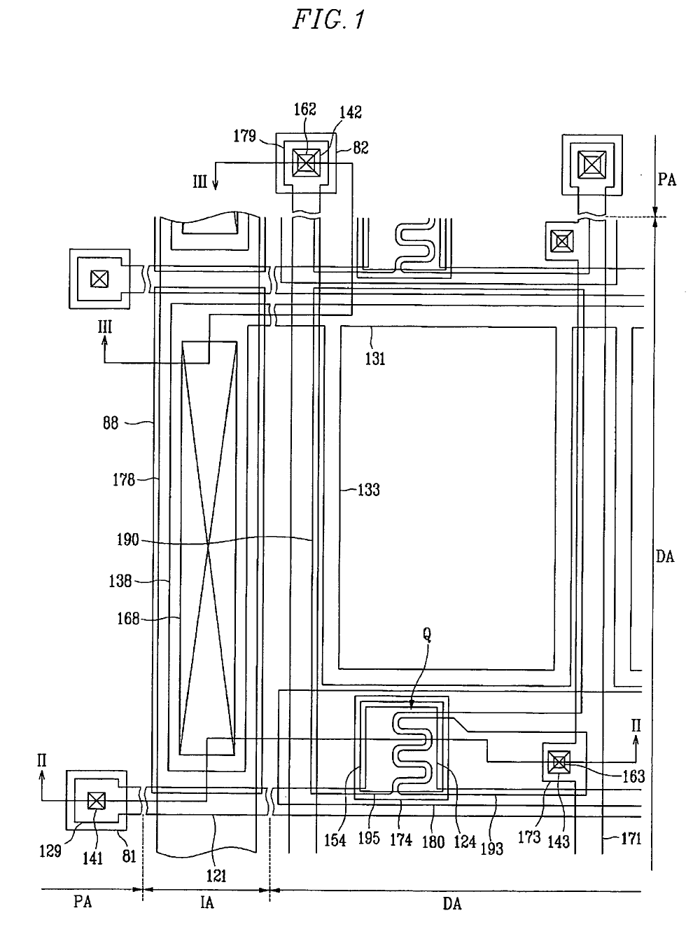

An organic TFT array panel for a liquid crystal display according to an embodiment of the present invention will be described in detail with reference to FIGS. 1, 2 and 3.

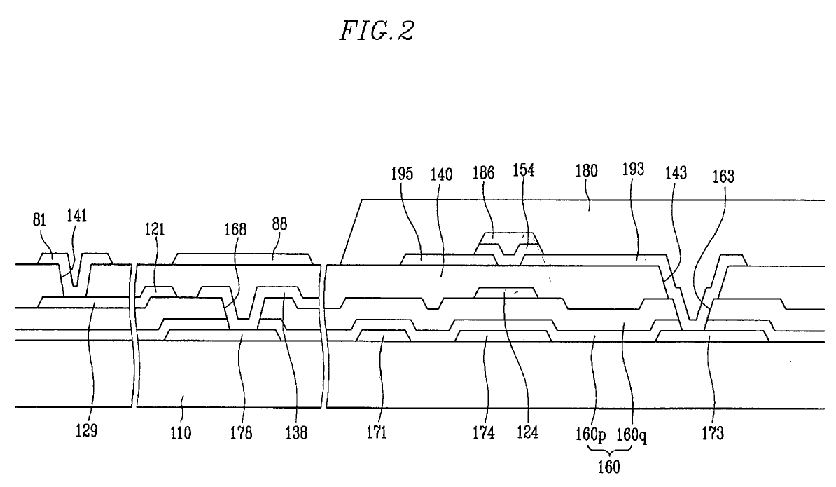

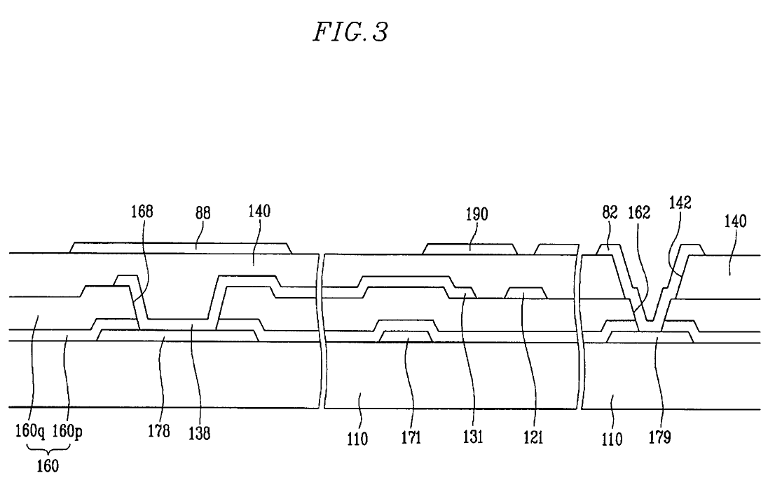

FIG. 1 is a plan view layout of an exemplary embodiment of an organic TFT array panel according to the present invention, FIG. 2 is a cross-sectional view of the organic TFT array panel shown in FIG. 1 taken along line II-II′ and FIG. 3 is a cross-sectional view of the organic TFT array panel shown in FIG. 1 taken along line III-III′.

As best seen with reference to FIG. 1, an organic TFT array panel includes a display area DA, a pad area PA located around the display area DA and an intermediate area IA disposed between the display area DA and the pad area PA.

A plurality of data conductors including a plurality of data lines 171, a plurality of light blocking members 174 and a storage connection 178 are formed on an insulating substrate 110 such as transparent glass, silicone, or plastic, for example.

The data lines 171 transmit data signals and extend substantially in a longitudinal direction in the display area DA as illustrated in FIG. 1. Each data line 171 includes a plurality of projections 173 in the display area DA and each data line 171 extends to the pad area PA, which includes an end portion 179 having a large surface area for contact with another layer or an external driving circuit. A data driving circuit (not shown) for generating the data signals may be mounted on a flexible printed circuit (“FPC”) film (not shown), which may be attached to the substrate 110, directly mounted on the substrate 110, or integrated with the substrate 110. The data lines 171 may extend to be connected to a driving circuit that may be integrated on the substrate 110.

The light blocking members 174 are disposed in the display area DA.

The storage connection 178 transmits a predetermined voltage such as a common voltage and extends in the longitudinal direction in the intermediate area IA as illustrated in FIG. 1.

The data conductors 171, 174 and 178 are preferably made of an Al containing metal such as Al and Al alloy, Ag containing metal such as Ag and Ag alloy, Au containing metal such as Au and Au alloy, Cu containing metal such as Cu and Cu alloy, Mo containing metal such as Mo and Mo alloy, Cr, Ta or Ti. However, the data conductors 171, 174 and 178 may have a multi-layered structure including two conductive films (not shown) having different physical characteristics. One of the two films is preferably made of a low resistivity metal to reduce signal delay or voltage drop and may include an Al containing metal, Ag containing metal, and/or a Cu containing metal. The other film is preferably made of a material such as a Mo containing metal, Cr, Ta, or Ti, which has good physical, chemical and electrical contact characteristics with other materials such as indium tin oxide (ITO) or indium zinc oxide (IZO), or good adhesion with the substrate 110. Examples of the combination of the two films include a lower Cr film and an upper Al (alloy) film and a lower Al (alloy) film and an upper Mo (alloy) film. However, the data conductors 171, 174 and 178 may be made of various other metals or conductors.

The data conductors 171, 174 and 178 have inclined edge profiles, and the inclination angles thereof range from about 30 to about 80 degrees relative to a major surface of substrate 110 from which they extend.

An interlayer insulating layer 160, including lower and upper insulating films 160p and 160q, respectively, is formed on the data conductors 171, 174 and 178. The lower insulating film 160p may be made of an inorganic insulator such as silicon nitride (SiNx) and silicon oxide (SiOx). The upper insulating film 160q may be made of an organic insulator such as polyacryl, polyimide, and benzocyclobutene (BCB; C₁₀H₈) having good durability. It will be recognized that one of the lower and the upper insulating films 160p and 160q may be omitted.

The interlayer insulating layer 160 has a plurality of contact holes 162 exposing the end portions 179 of the data lines 171, a plurality of contact holes 163 exposing the projections 173 of the data lines 171 and a plurality of contact holes 168 exposing the storage connection 178.

A plurality of gate lines 121 and a plurality of storage electrode lines 131 are formed on the interlayer insulating layer 160. The gate lines 121 transmit gate signals and extend substantially in a transverse or lateral direction in the display area DA, as illustrated in FIG. 1. The gate lines 121 include a plurality of gate electrodes 124 projecting upward and disposed on the light blocking members 174, as illustrated in FIG. 2. Each of the gate lines 121 extends to the pad area PA through the intermediate area IA to include an end portion 129 having a large surface area for contact with another layer or an external driving circuit. A gate driving circuit (not shown) for generating the gate signals may be mounted on a FPC film (not shown), which may be attached to the substrate 110, directly mounted on the substrate 110, or integrated with the substrate 110. The gate lines 121 may extend to be connected to a driving circuit that may be integrated with the substrate 110.

The storage electrode lines 131 are supplied with a predetermined voltage. As best seen with reference to FIG. 1, each of the storage electrode lines 131 includes a stem, a plurality of storage electrodes 133 and an end portion 138. Each of the storage electrode lines 131 is disposed between two adjacent gate lines 121.

The stem extends substantially parallel to the gate lines 121 in the display area DA and extends to the intermediate area IA. The stem is close to an upper one of the two adjacent gate lines 121, as illustrated in FIG. 1. The end portion 138 is disposed in the intermediate area IA and has a large surface area to be connected to the storage connection 178 through a contact hole 168.

Each of the storage electrodes 133 is branched from the stem in the display area DA and forms a rectangle along with the stem to define a closed area. However, the storage electrode lines 131 may have various shapes and arrangements and is not limited to a rectangle as illustrated in FIG. 1.

The gate lines 121 and the storage electrode lines 131 may be made of the same material as the data conductors 171, 174 and 178. The lateral sides of the gate lines 121 and the storage electrode lines 131 are inclined relative to a surface of the substrate 110, and the inclination angle thereof ranges from about 30 to about 80 degrees.

A gate insulating layer 140 is formed on the gate lines 121 and the storage electrode lines 131. The gate insulating layer 140 may be made of an inorganic or organic insulator and may have a flat surface and a thickness of about 0.6 microns to about 1.2 microns. Examples of the inorganic insulator include silicon nitride and silicon oxide that may have a surface treated with octadecyl-trichloro-silane (OTS). Examples of the organic insulator include hydrocarbon based polymer including fluorine and parylene that can be deposited by chemical vapor deposition (“CVD”) in a vacuum. In particular, parylene has excellent coating uniformity such that the thickness of a parylene film can be easily controlled from about 1 micron to about several microns. Furthermore, parylene has very low permittivity and has excellent insulation characteristics. In addition, polymerized parylene is soluble in almost all existent organic solvents and can be deposited at room temperature to avoid heat stress. Moreover, the parylene film is environmentally friendly in that it can be formed using a dry process without using liquid chemicals. Other examples of the organic insulator include maleimide-styrene, polyvinylphenol (PVP) and modified cyanoethyl pullulan (m-CEP).

The gate insulating layer 140 has a plurality of contact holes 141 exposing the end portions 129 of the gate lines 121, a plurality of contact holes 142 exposing the contact holes 162 and a plurality of contact holes 143 exposing the contact holes 163.

A plurality of source electrodes 193, a plurality of pixel electrodes 190, a plurality of storage covers 88 and a plurality of contact assistants 81 and 82 are formed on the gate insulating layer 140. They are preferably made of ITO, particularly amorphous ITO. However, they may be made of another transparent conductor such as IZO or a reflective conductor such as Ag, Al, Au, or alloys thereof. The source electrodes 193 are connected to the data lines 171 through the contact holes 143 and 163.

Each pixel electrode 190 includes a portion 195 (FIG. 3) disposed opposite a source electrode 193 with respect to a gate electrode 124. Portion 195 of each pixel electrode 190 is referred to as a drain electrode 195 hereinafter. The drain electrodes 195 and the source electrodes 193 have serpentine edges that face each other and extend substantially parallel to each other, as illustrated in FIG. 1. The pixel electrodes 190 overlap the gate lines 121 and the data lines 171 to increase the aperture ratio.

The contact assistants 81 and 82 are connected to the end portions 129 of the gate lines 121 and the end portions 179 of the data lines 171 through the contact holes 141 and 142, respectively. The contact assistants 81 and 82 protect the end portions 129 and 179, respectively, and enhance the adhesion between the end portions 129 and 179 and external devices. In particular, it is preferable that the contact assistants 81 fully cover the area occupied by the end portion 129 of the gate lines 121.

The storage covers 88 are disposed in the intermediate area IA and fully cover the end portions 138 of the storage electrode lines 131 and portions of the storage connection 178. The storage covers 88 prevent the end portions 138 of the storage electrodes lines 131 from being damaged by etchant.

The damage on the end portions 138 of the storage electrode lines 131 may be caused by cracks generated in the gate insulating layer 140. The cracks may be generated by the height difference and may provide an etchant, for the pixel electrodes 190 and the contact assistants 81, with a path to reach underlying gate lines 121 and storage electrode lines 131. The number of cracks generated may increase when the gate insulating layer 140 has poor step coverage. The storage covers 88 cover the entire area occupied by the end portions 138 to block the etchant from intruding into the cracks on the end portions 138. The contact assistants 81 covering an entire area of the end portions 129 of the gate lines 121 may have the same role as the storage covers 88.

A plurality of organic semiconductor islands 154 are formed on the source electrodes 193, the drain electrode 195 and the gate insulating layer 140. The organic semiconductor islands 154 are disposed on the gate electrodes 124 and contact the source electrodes 193 and the drain electrodes 195.

The organic semiconductor islands 154 may include an insoluble low molecular compound and may be formed by deposition including vacuum evaporation with a shadow mask. However, the organic semiconductor islands 154 may include a high molecular compound or a low molecular compound, which is soluble in an aqueous solution or organic solvent. In this case, the organic semiconductor islands 154 can be formed by (e.g., inkjet) printing with a bank (not shown).

The organic semiconductor islands 154 may be made of, or from derivatives of, tetracene or pentacene with substituent. Alternatively, the organic semiconductor islands 154 may be made of oligothiophene including four to eight thiophenes connected at the positions 2, 5 of thiophene rings.

The organic semiconductor islands 154 may be made of thienylene, polyvinylene or thiophene.

A gate electrode 124, a source electrode 193 and a drain electrode 195 along with an organic semiconductor island 154 form an organic TFT Q having a channel formed in the organic semiconductor island 154 disposed between the source electrode 193 and the drain electrode 195, as illustrated with reference to FIGS. 1 and 3.

The pixel electrodes 190 receive data voltages from the organic TFT Q and generate electric fields in cooperation with a common electrode (not shown) of an opposing display panel (not shown) supplied with a common voltage, which determines the orientations of liquid crystal molecules (not shown) of a liquid crystal layer (not shown) disposed between the two electrodes. A pixel electrode 190 and the common electrode form a capacitor referred to as a “liquid crystal capacitor,” which stores applied voltages after the organic TFT Q turns off.

The light blocking members 174, which are disposed under the gate electrodes 124 and the organic semiconductor islands 154, block incident light to prevent current leakage induced by light.

Stoppers 186 are formed on respective organic semiconductor islands 154. The stoppers 186 have substantially the same planar shape as the organic semiconductor islands 154. The stoppers 186 are preferably made of an insulating material that can be dry processed and deposited under low temperature. Examples of such a material are polyvinyl alcohol (PVA), hydrocarbon based polymer including fluorine or parylene that can be formed at room temperature or low temperature. The stoppers 186 protect the organic semiconductor islands 154 from being damaged in the manufacturing process.

A plurality of passivation members 180 are formed on the organic TFTs Q and the stoppers 186. The passivation members 180 are preferably made of an inorganic or organic insulator and may have a flat top surface. Examples of the inorganic insulator include silicon nitride and silicon oxide. The organic insulator may have photosensitivity and a dielectric constant less than about 4.0.

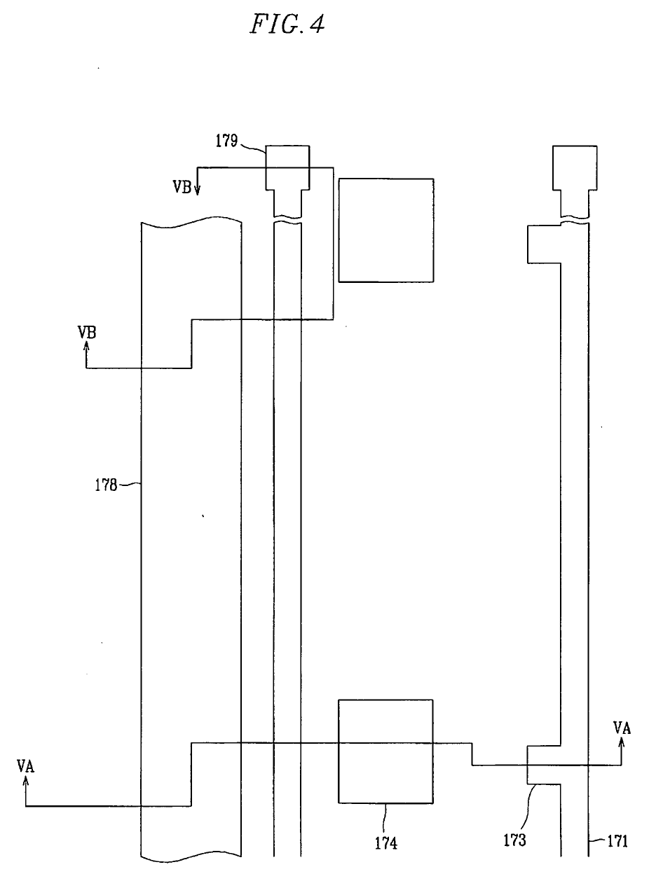

Now, a method of manufacturing the exemplary embodiment of the TFT array panel shown in FIGS. 1-3 according to another exemplary embodiment of the present invention will be described in detail with reference to FIGS. 4-15 as well as FIGS. 1-3.

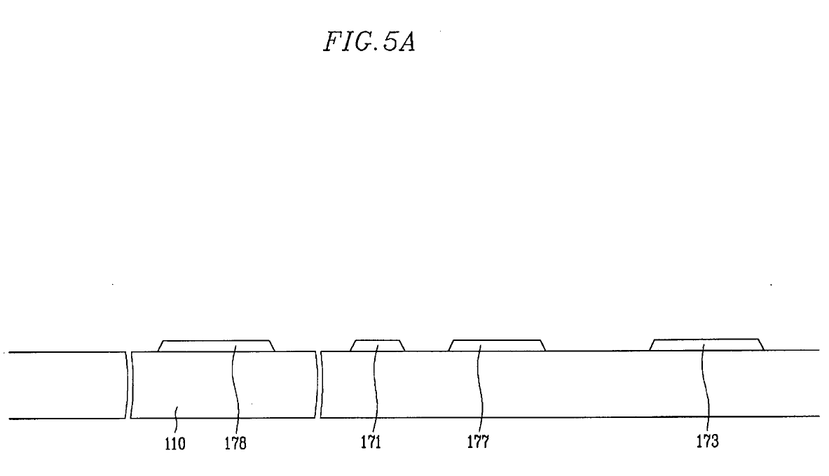

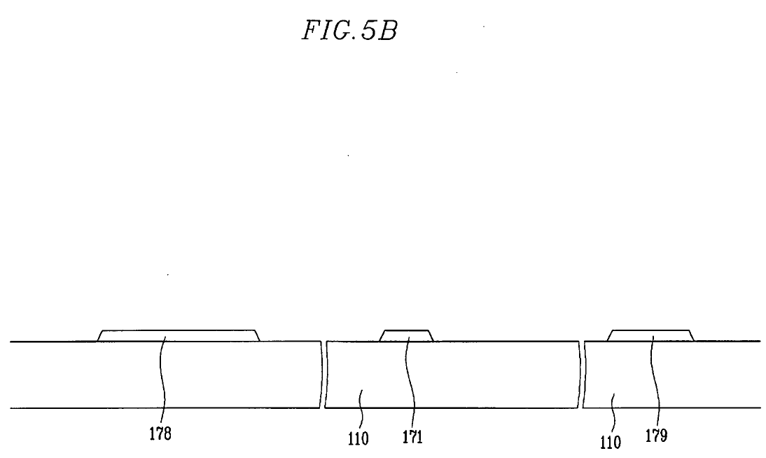

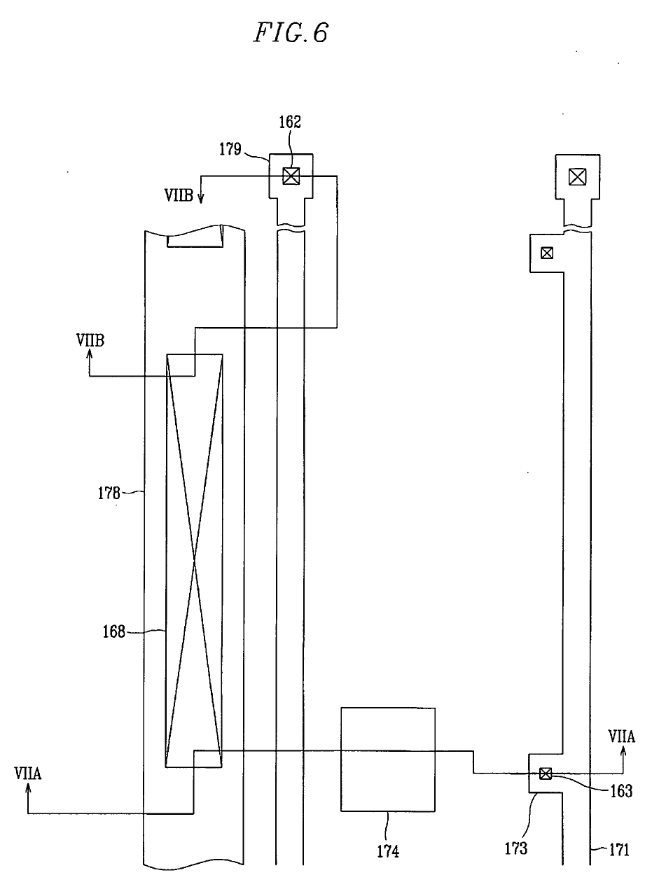

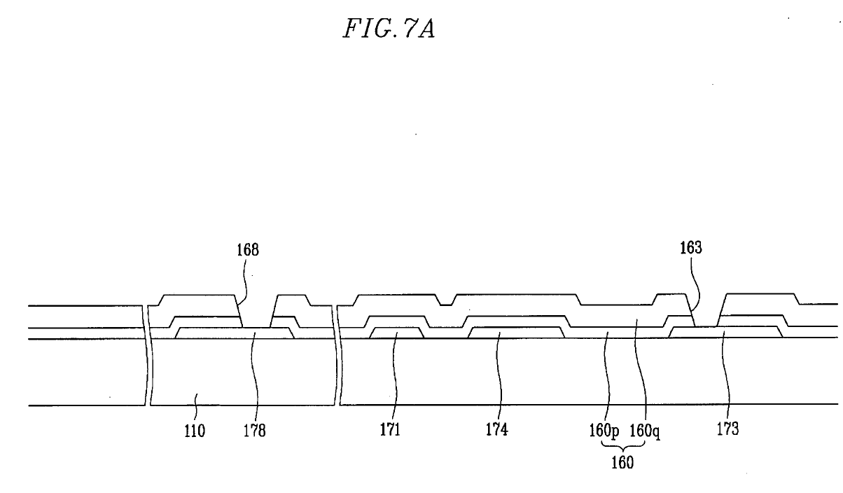

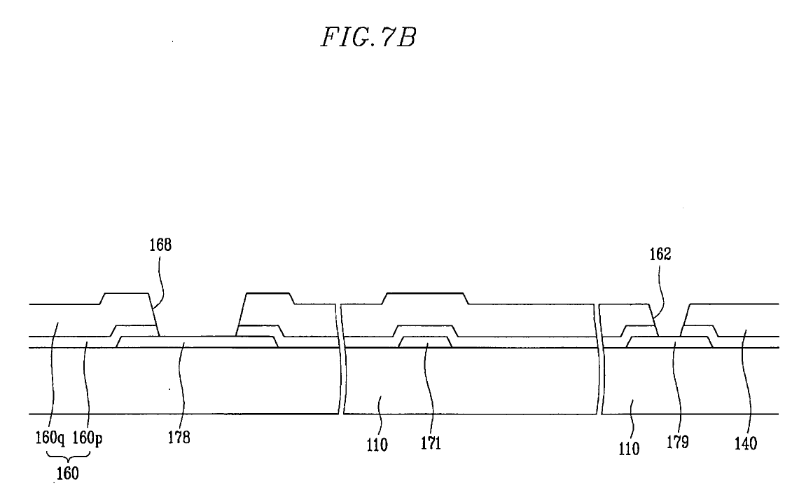

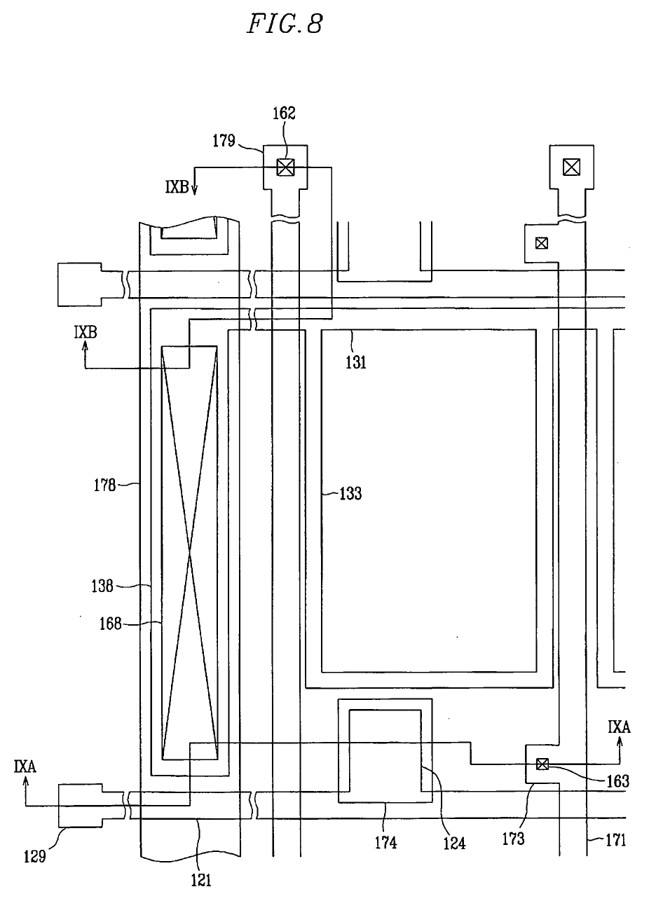

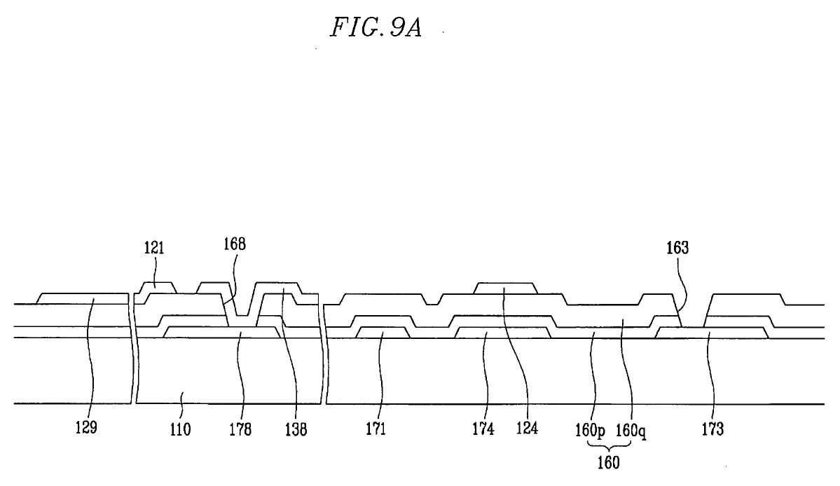

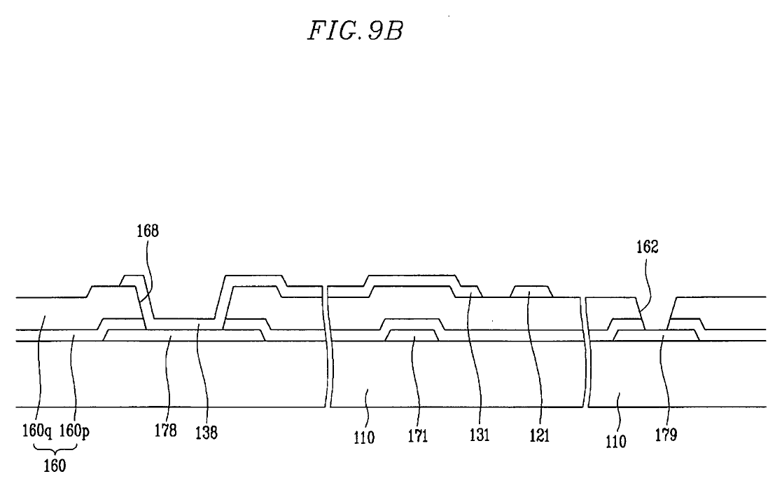

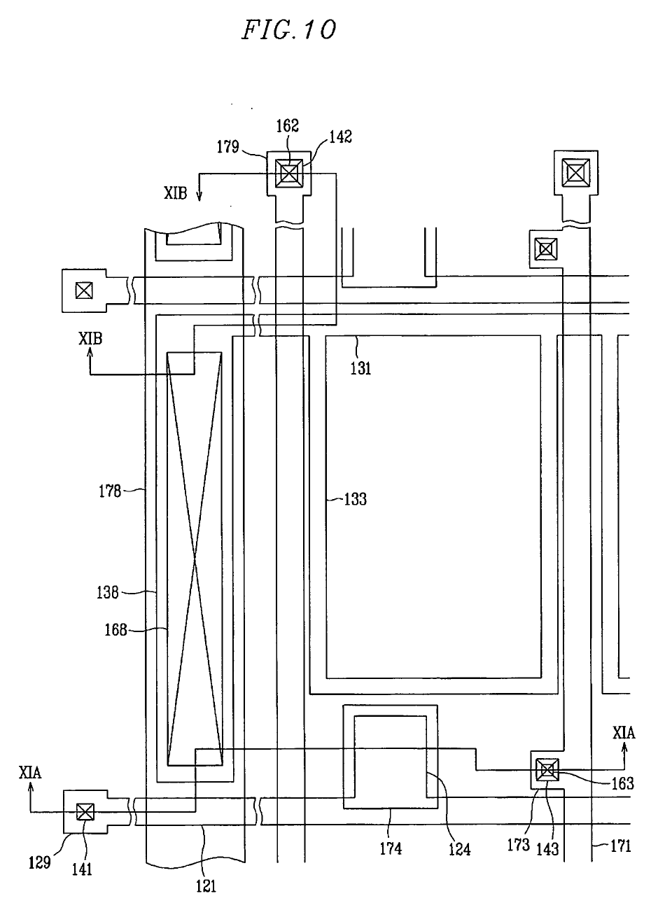

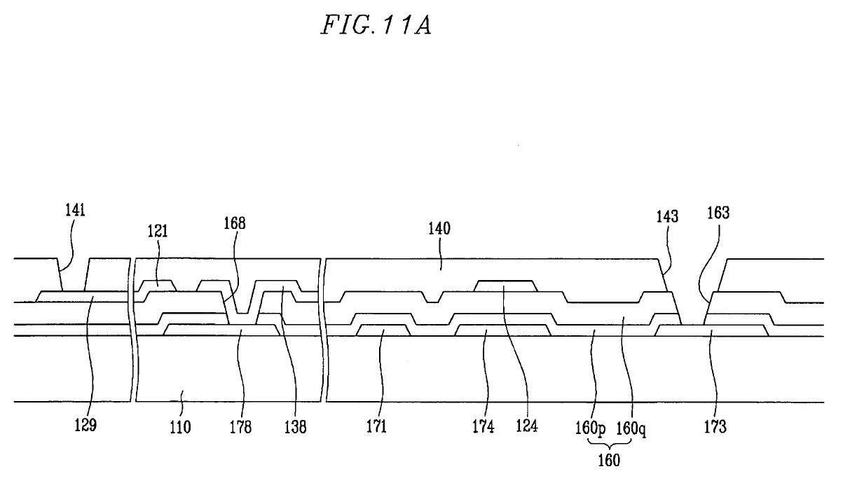

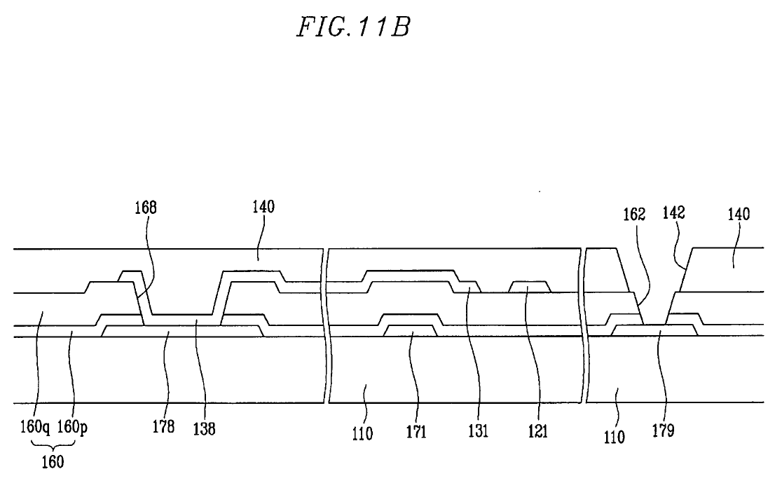

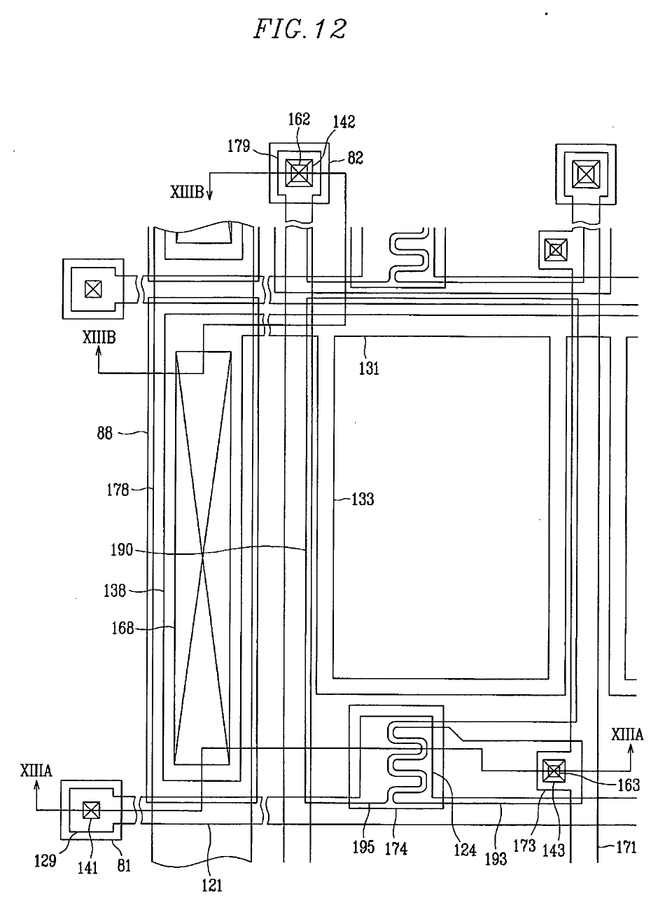

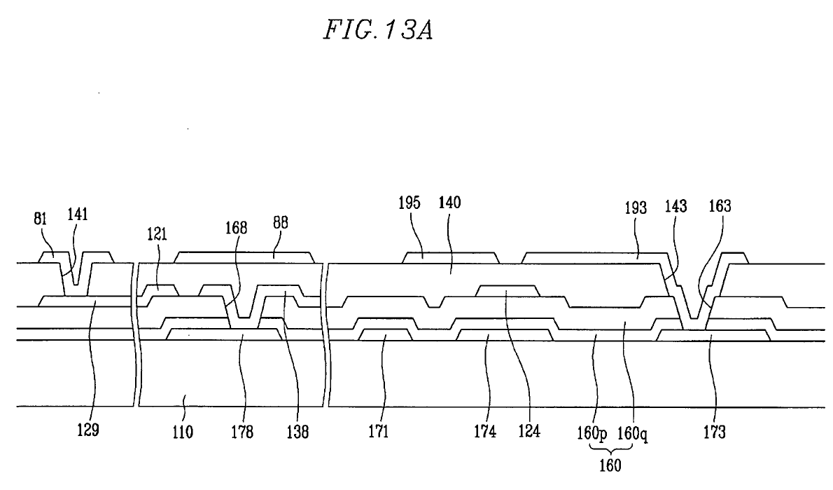

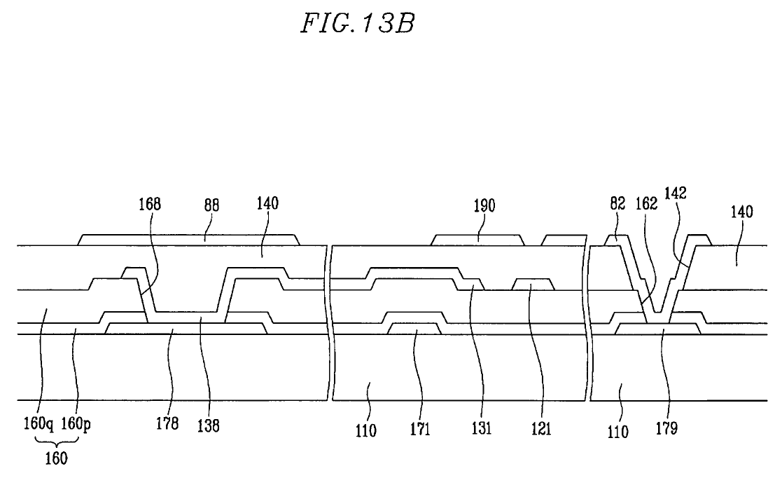

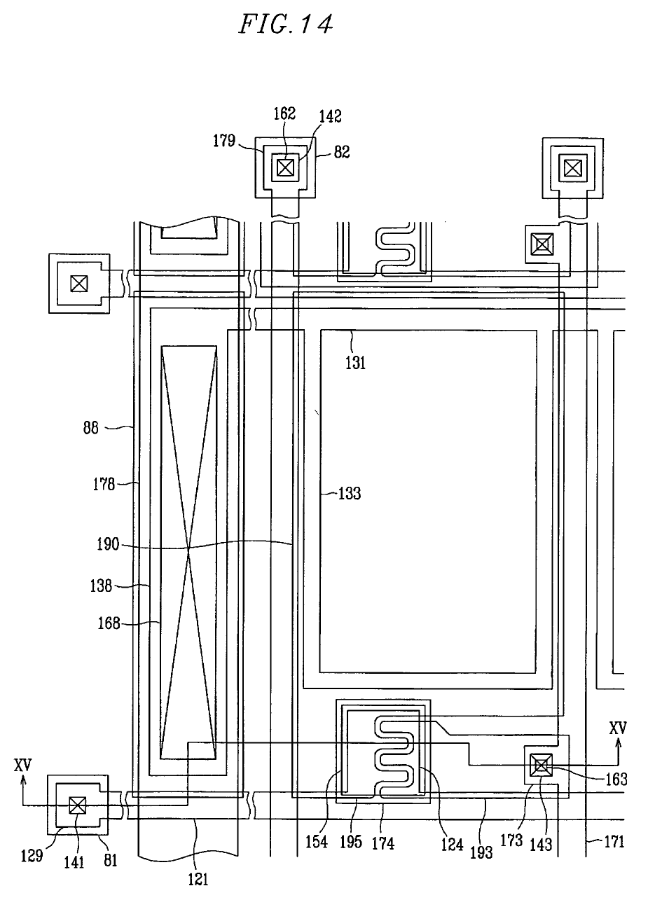

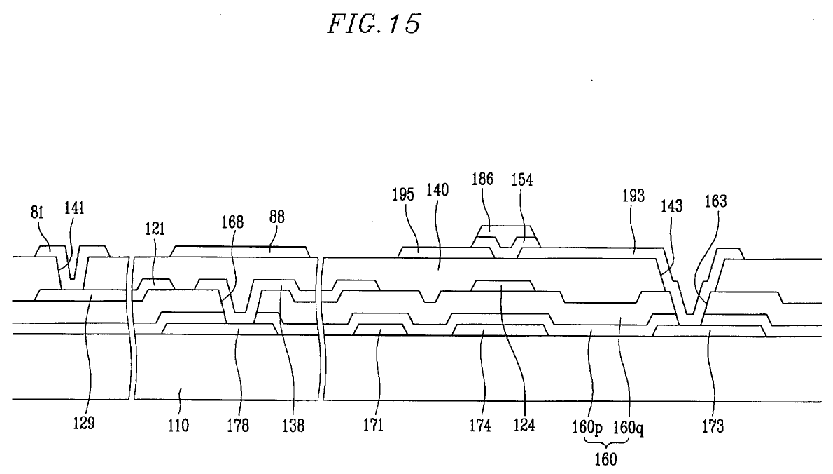

FIGS. 4, 6, 8, 10, 12 and 14 are plan view layouts of the organic TFT array panel shown FIGS. 1-3 illustrating intermediate steps of an exemplary embodiment of a manufacturing method thereof according to the present invention. FIGS. 5A and 5B are cross-sectional views of the TFT array panel shown in FIG. 4 taken along lines VA-VA′ and VB-VB′. FIGS. 7A and 7B are cross-sectional views of the TFT array panel shown in FIG. 6 taken along lines VIIA-VIIA′ and VIIB-VIIB′. FIGS. 9A and 9B are cross-sectional views of the TFT array panel shown in FIG. 8 taken along lines IXA-IXA′ and IXB-IXB′. FIGS. 11A and 11B are cross-sectional views of the TFT array panel shown in FIG. 10 taken along lines XIA-XIA′ and XIB-XIB′. FIGS. 13A and 13B are cross-sectional views of the TFT array panel shown in FIG. 12 taken along lines XIIIA-XIIIA′ and XIIIB-XIIIB′. FIG. 15 is a cross-sectional view of the TFT array panel shown in FIG. 14 taken along line XV-XV′.

Referring to FIGS. 4-5B, a conductive layer is deposited on a substrate 110 by using sputtering, for example, and patterned by lithography and etching to form a plurality of data lines 171 including projections 173 and end portions 179 extending from the plurality of data lines 171, a plurality of light blocking members 174, and a storage connection 178.

Referring to FIGS. 6-7B, an interlayer insulating layer 160 including lower and upper insulating films 160p and 160q, respectively, is deposited. The lower insulating film 160p may be made of an inorganic material and deposited by chemical vapor deposition (“CVD”), for example, and the upper insulating film 160q may be made of a photosensitive organic material and deposited by spin coating, for example.

The upper insulating film 160q is then subjected to light exposure and development to form upper walls of a plurality of contact holes 162, 163 and 168. Thereafter, the lower insulating film 160p is dry etched using the upper insulating film 160q as an etch mask to complete the contact holes 162, 163 and 168.

Referring to FIGS. 8-9B, a conductive layer is deposited on the interlayer insulating layer 160 and patterned by lithography and etching to form a plurality of gate lines 121 including gate electrodes 124 and end portions 129 extending from the plurality of gate lines 121 and a plurality of storage electrode lines 131 including storage electrodes 133 and end portions 138 extending from the storage electrode lines 131. The end portions 138 are connected to the storage connection 178 through the contact holes 168.

Referring to FIGS. 10-11B, a photosensitive gate insulating layer 140 having a thickness of about 0.6 microns to about 1 micron is coated and is subjected to light exposure and development to form a plurality of contact holes 141, 142 and 143 exposing the end portions 129 of the gate lines 121, the contact holes 162 and the contact holes 163, respectively.

Referring to FIGS. 12-13B, an amorphous ITO layer is deposited on the gate insulating layer 140 and patterned by lithography and wet etching with an etchant to form a plurality of source electrodes 193, a plurality of pixel electrodes 190 including drain electrodes 195, a plurality of storage covers 88, and a plurality of contact assistants 81 and 82. The storage covers 88 cover the entire area occupied by the end portions 138 of the storage electrode lines 131. Portions of the storage connection 178, such as the wide photoresist film portions for the storage covers 88 used in the lithography step, prevent the etchant from exerting damage on the end portions 138 of the storage electrode lines 131.

The deposition of the amorphous ITO layer may be performed at a temperature lower than about 80° C., preferably at room temperature. The etchant for the amorphous ITO layer may include a weak alkaline etchant containing amine (NH₂) to reduce the damage to the gate insulating layer 140. Annealing may be optionally added for converting the amorphous ITO into crystalline ITO.

Referring to FIGS. 14 and 15, a plurality of organic semiconductor islands 154 are formed by molecular beam deposition, vapor deposition, vacuum sublimation, CVD, PECVD, reactive deposition, sputtering, spin coating, contact printing, or inkjet printing, for example, with or without a shadow mask.

Thereafter, stoppers 186 are formed on the respective organic semiconductor islands 154. The stoppers 186 are preferably made of an insulating material that can be dry processed and deposited under low temperature. Examples of such a material include PVA, hydrocarbon based polymer including fluorine, or parylene that can be formed at room temperature or low temperature. The stoppers 186 protect the respective organic semiconductor islands 154 from being damaged in successive manufacturing steps.

Finally, an insulating layer is deposited and patterned to form a plurality of passivation members 180 as shown in FIGS. 1-3.

The exemplary embodiments of the present invention can be employed in any display device including an LCD or OLED display.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An organic thin film transistor array panel comprising:
a substrate;
a plurality of data lines disposed on the substrate;
a storage connection disposed on the substrate;
a plurality of gate lines intersecting the data lines, the plurality of gate lines including gate electrodes;
a plurality of storage electrode lines separated from the gate lines and connected to the storage connection;
a gate insulating layer disposed on the gate lines and the storage electrode lines, the gate insulating layer having contact holes exposing the data lines;
a plurality of first electrodes disposed on the gate insulating layer and connected to the data lines through the contact holes;
a plurality of second electrodes disposed opposite the first electrodes relative to respective corresponding gate electrodes;
a plurality of storage covers disposed on the gate insulating layer opposite the storage connection; and
a plurality of organic semiconductors disposed on the plurality of first and second electrodes and contacting the plurality of first and second electrodes.

2. The organic thin film transistor array panel of claim 1, wherein the storage covers are disposed on the same gate insulating layer as the second electrodes.

3. The organic thin film transistor array panel of claim 2, wherein the storage covers and the second electrodes comprise amorphous or crystalline ITO.

4. The organic thin film transistor array panel of claim 1, wherein the storage covers cover an entire width of the storage connection.

5. The organic thin film transistor array panel of claim 1, wherein the organic semiconductors comprise at least one selected from pentacene, phthalocyanine, and thiophene.

6. The organic thin film transistor array panel of claim 1, further comprising a plurality of insulators disposed on the organic semiconductors.

7. The organic thin film transistor array panel of claim 6, wherein the insulators comprise a hydrocarbon based polymer including fluorine or polyvinyl alcohol.

8. The organic thin film transistor array panel of claim 1, further comprising an interlayer insulating layer disposed between the plurality of data lines and gate lines.

9. The organic thin film transistor array panel of claim 8, wherein the interlayer insulating layer comprises a silicon nitride film and an organic film.

10. The organic thin film transistor array panel of claim 1, wherein the gate insulating layer comprises silicon oxide treated with octadecyl trichloro silane (OTS), maleimide-styrene, and parylene.

11. The organic thin film transistor array panel of claim 1, further comprising a plurality of conductive light blocking members disposed under respective corresponding gate electrodes.

12. The organic thin film transistor array panel of claim 1, further comprising a plurality of passivation members disposed on respective corresponding organic semiconductors.

13. A method of manufacturing an organic thin film transistor array panel, the method comprising:
forming data lines and a storage connection;
depositing an interlayer insulating layer on the data lines and the storage connection;
forming first contact holes exposing portions of the data lines and second contact holes exposing the storage connection at the interlayer insulating layer;
forming gate lines including gate electrodes and storage electrode lines on the interlayer insulating layer, the storage electrode lines connected to the storage connection through the second contact holes;
depositing a gate insulating layer on the gate lines and the storage electrode lines;
forming third contact holes exposing the first contact holes;
forming source electrodes, pixel electrodes and storage covers, the source electrodes connected to the data lines through the first and the third contact holes, the pixel electrodes including drain electrodes disposed opposite the source electrodes; and
forming organic semiconductors on the source electrodes and the drain electrodes.

14. The method of claim 13, wherein the forming source electrodes, pixel electrodes and the storage covers comprises:
depositing an ITO layer; and
patterning the ITO layer by lithography and etching.

15. The method of claim 14, wherein the deposition of the ITO layer is performed at room temperature.

16. The method of claim 15, wherein the patterning of the ITO layer uses an etchant containing an alkaline ingredient.

17. The method of claim 13, wherein the storage covers cover an entire width of the storage connection.

18. The method of claim 13, wherein the forming organic semiconductors comprises one of spin coating, vacuum evaporation and printing.

19. The method of claim 13, further comprising:
forming stoppers on the organic semiconductors.

20. The method of claim 19, wherein the stoppers comprise a hydrocarbon based polymer including fluorine or polyvinyl alcohol.

21. The method of claim 13, further comprising:
forming passivation members on the organic semiconductors.

22. The method of claim 13, wherein the depositing an interlayer insulating layer comprises:
forming a first insulating layer including silicon nitride; and
forming a second insulating layer including an organic material.

23. The method of claim 13, wherein the forming data lines and a storage connection forms light blocking members under corresponding gate electrodes.
